(19) United States
(12) Patent Application Publication
(10) Pub. No.: US 2022/0076210 A1
(43) Pub. Date: Mar. 10, 2022

(54) SYSTEM AND METHOD FOR REACTIVE MULTI-PART PARSING FOR USE WITH A MICROSERVICES OR OTHER COMPUTING ENVIRONMENT

(71) Applicant: Oracle International Corporation, Redwood Shores, CA (US)

(72) Inventor: OLEKSANDR OTENKO, Winnersh (GB)

(21) Appl. No.: 17/410,733

(22) Filed: Aug. 24, 2021

Related U.S. Application Data
(60) Provisional application No. 63/075,011, filed on Sep. 4, 2020.

(51) Int. Cl. G06Q 10/10; G06F 40/205

(52) U.S. Cl. CPC G06Q 10/107; G06F 40/205

(57) ABSTRACT

In accordance with an embodiment, described herein is a system and method for providing reactive multi-part parsing for use with a microservices or other computing environment. In a cloud computing environment, reactive programming can be used with publishers and subscribers, to abstract execution away from the thread of execution while providing rigorous coordination of various state transitions. The described approach provides support for parsing multi-part Multipurpose Internet Mail Extensions (MIME) or other data content, for example to provide a multi-part decoder, or as may be used with a web or other server.

### CLAIM OF PRIORITY

This application claims the benefit of priority to U.S. Provisional patent application titled “SYSTEM AND METHOD FOR REACTIVE MULTIPART MIME PARSING FOR USE WITH A MICROSERVICES OR OTHER COMPUTING ENVIRONMENT”, Application No. 63/075,011, filed Sep. 4, 2020; which application is herein incorporated by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

Embodiments described herein are generally related to cloud computing, software development, and microservice architectures, and are particularly directed to reactive multi-part parsing for use with a microservices or other computing environment.

### BACKGROUND

Microservice environments can present a software application as a collection of loosely-coupled services that are independently deployable and communicate with one another over a network. The microservice approach can be used, for example, to develop software applications to be provided in cloud computing environments as cloud services. In such environments, microservices can be used to provide elasticity, and to make efficient use of computational resources.

### SUMMARY

In accordance with an embodiment, described herein is a system and method for providing reactive multi-part parsing for use with a microservices or other computing environment. In a cloud computing environment, reactive programming can be used with publishers and subscribers, to abstract execution away from the thread of execution while providing rigorous coordination of various state transitions. The described approach provides support for parsing multi-part Multipurpose Internet Mail Extensions (MIME) or other data content, for example to provide a multi-part decoder, or as may be used with a web or other server.

### BRIEF DESCRIPTION OF THE DRAWINGS

FIG. 1 illustrates an example microservices environment that provides a software development framework, in accordance with an embodiment.

FIG. 2 illustrates an example Helidon SE microservices environment, in accordance with an embodiment.

FIG. 3 illustrates an example Helidon MP microservices environment, in accordance with an embodiment.

FIG. 4 illustrates the use of a remote procedure call framework in a microservices environment, in accordance with an embodiment.

FIG. 5 illustrates the use of a reactive messaging client in a microservices environment, in accordance with an embodiment.

FIG. 6 further illustrates the use of a reactive environment, in accordance with an embodiment.

FIG. 7 further illustrates the use of a reactive environment, in accordance with an embodiment.

FIG. 8 further illustrates the use of a reactive environment, in accordance with an embodiment.

FIG. 9 illustrates a multi-part publisher for use with a microservices or other computing environment, in accordance with an embodiment.

FIG. 10 further illustrates a multi-part publisher for use with a microservices or other computing environment, in accordance with an embodiment.

FIG. 11 further illustrates a multi-part publisher for use with a microservices or other computing environment, in accordance with an embodiment.

FIG. 12A further illustrates a multi-part publisher for use with a microservices or other computing environment, in accordance with an embodiment.

FIG. 12B further illustrates a multi-part publisher for use with a microservices or other computing environment, in accordance with an embodiment.

FIG. 12C further illustrates a multi-part publisher for use with a microservices or other computing environment, in accordance with an embodiment.

FIG. 13 further illustrates a multi-part publisher for use with a microservices or other computing environment, in accordance with an embodiment.

FIG. 14 further illustrates a multi-part publisher for use with a microservices or other computing environment, in accordance with an embodiment.

FIG. 15 further illustrates a multi-part publisher for use with a microservices or other computing environment, in accordance with an embodiment.

FIG. 16 further illustrates a multi-part publisher for use with a microservices or other computing environment, in accordance with an embodiment.

FIG. 17 further illustrates a multi-part publisher for use with a microservices or other computing environment, in accordance with an embodiment.

FIG. 18 further illustrates a multi-part publisher for use with a microservices or other computing environment, in accordance with an embodiment.

### DETAILED DESCRIPTION

As described above, microservice architectures can present a software application as a collection of loosely-coupled services that are independently deployable and communicate with one another over a network. The microservice approach can be used, for example, to develop software applications to be provided in cloud computing environments as cloud services. In such environments, microservices can be used to provide elasticity, and to make efficient use of computational resources.

Software development frameworks such as Helidon assist in the development of microservices. For example, Helidon offers Standard Edition (SE) and MicroProfile (MP) programming models or environments, each of which include a collection of software libraries that support features such as configuration, security, or web server functionality; and provide a software developer with a foundation upon which to create a microservice.

Generally described, Helidon alleviates the need for the software developer to program according to a specific tooling or deployment model, and enables the running of microservices without the need for an application server. Helidon libraries can interoperate with other software development, deployment, and/or monitoring tools such as, for example, Docker, Kubernetes, Prometheus, or OpenTracing.

### Microservices Environments (Helidon)

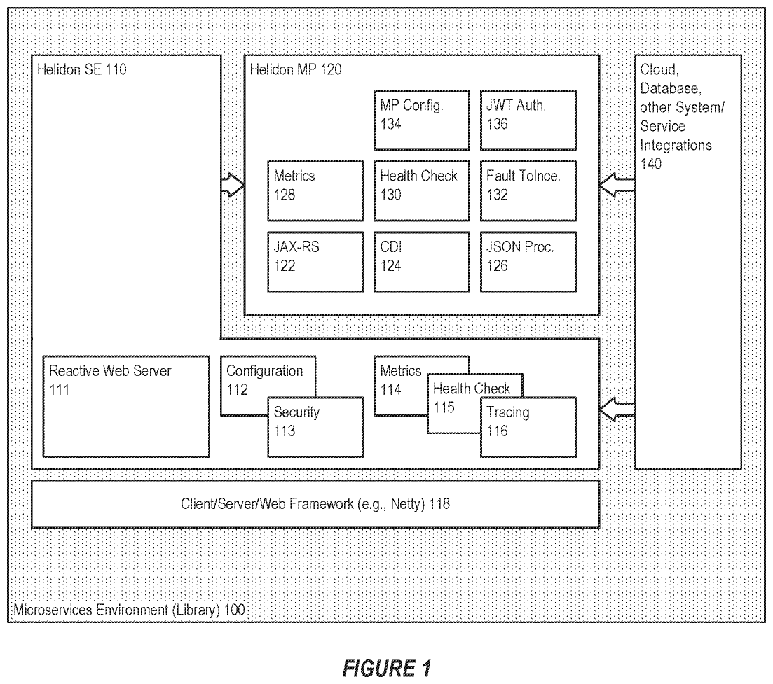

FIG. 1 illustrates an example microservices environment that provides a software development framework, in accordance with an embodiment.

As illustrated in FIG. 1, in accordance with an embodiment, a Helidon microservices environment 100 offers both Standard Edition (SE) and MicroProfile (MP) programming models or environments.

In accordance with an embodiment, a Helidon SE environment 110 can include various libraries, APIs, or other components, such as, for example, a reactive web server 111, which provides an asynchronous and reactive API for creating web applications; a configuration API 112, which provides a Java API to load and process configuration properties in key/value form into a config object which an application can then use to retrieve config data; and a security component 113, which provides authentication, authorization, and outbound security; and can also include metrics 114, health check 115, and tracing 116 or other components.

In accordance with an embodiment, a Helidon MP environment 120 can include various libraries, APIs, or other components, such as, for example, JAX-RS 122, JSON-P 126, CDI 124, metrics 128, health check 130 fault tolerance 132, MicroProfile configuration 134, and JWT authentication 136 components. In accordance with an embodiment, the web server can be provided by a non-blocking client/server/web framework 118, such as, for example, Netty. The microservices environment can also enable interactions with cloud, database, or other systems or services 140.

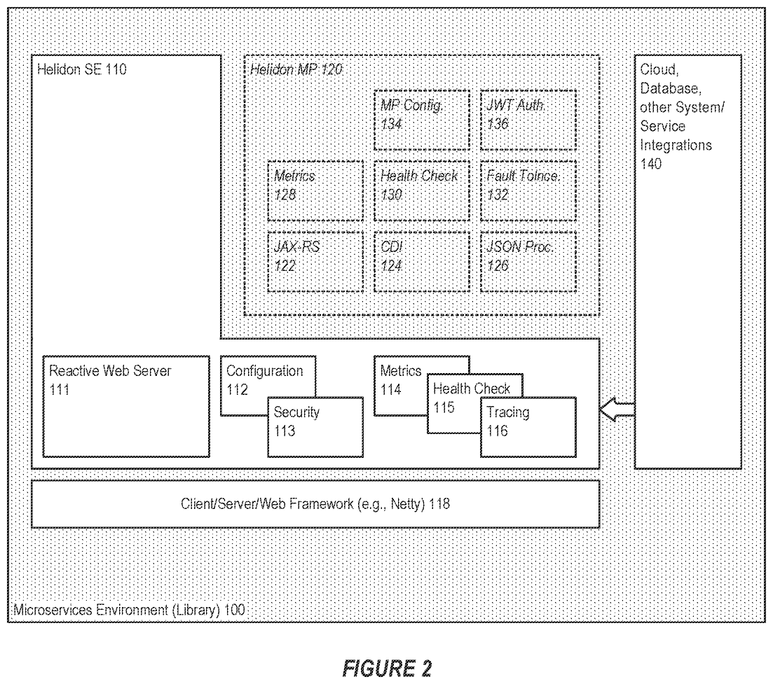

FIG. 2 illustrates an example Helidon SE microservices environment, in accordance with an embodiment.

As illustrated in FIG. 2, in accordance with an embodiment, a Helidon SE environment supports a functional programming style that uses the web server, security and configuration components directly; provides the software developer with transparency and control; and supports Java features such as reactive streams, and asynchronous and functional programming. A Helidon SE environment provides a framework by which the software developer can build lightweight reactive microservices.

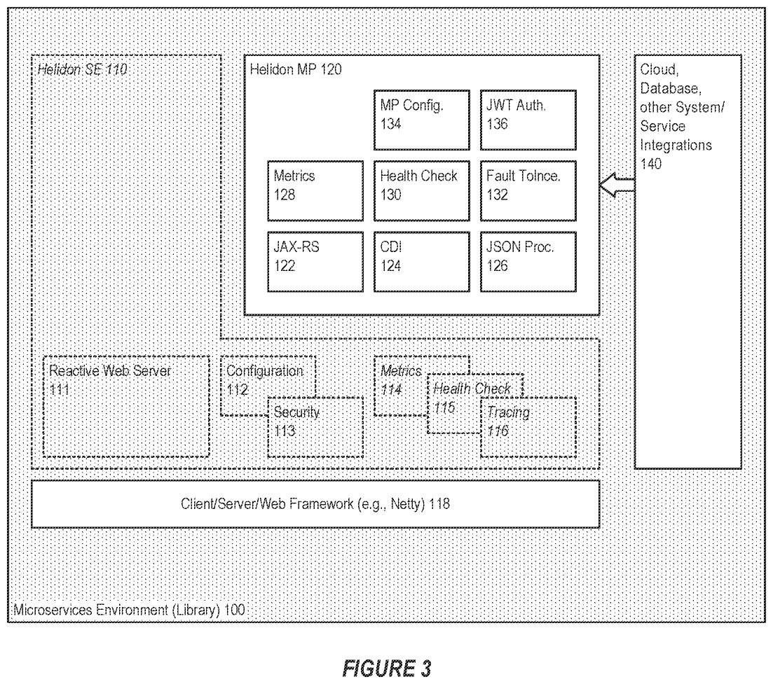

FIG. 3 illustrates an example Helidon MP microservices environment, in accordance with an embodiment.

As illustrated in FIG. 3, in accordance with an embodiment, a Helidon MP environment supports a declarative programming style, through the use of a MicroProfile family of APIs built on top of the Helidon libraries. A MicroProfile definition (for example, as specified by the Eclipse MicroProfile project) can be used to support application portability across multiple MicroProfile runtimes.

In accordance with an embodiment, a microservices environment can present a software application as a collection of loosely-coupled services that are independently deployable and communicate with one another over a network. For example, a Helidon microservices environment can support the use of a remote procedure call (e.g., gRPC) framework or component, which enables (client and/or server) applications to communicate within the microservices environment, to build connected systems.

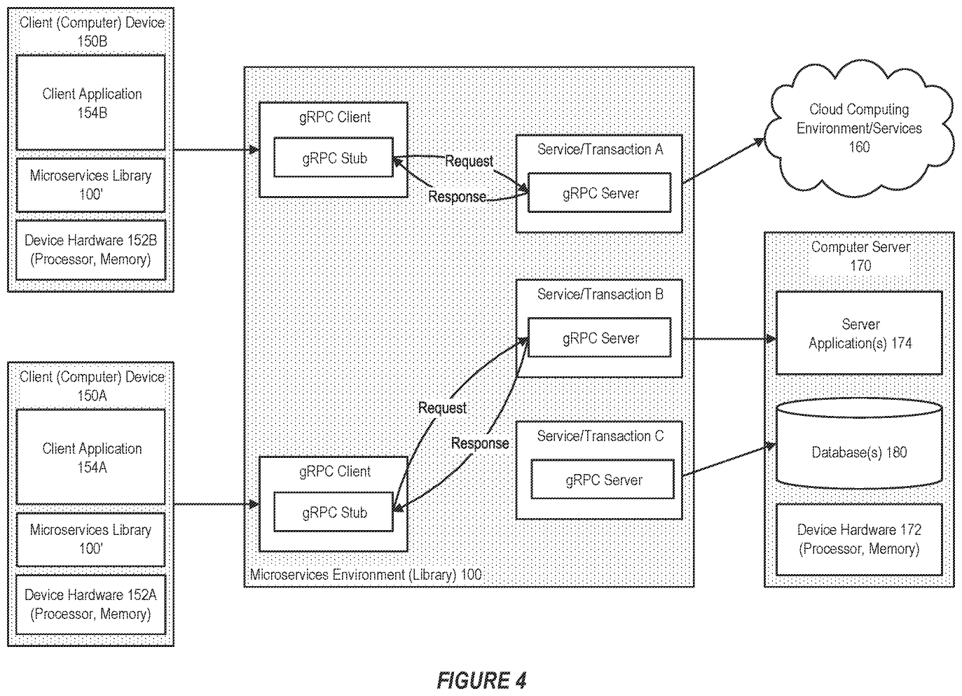

FIG. 4 illustrates communication in a microservices environment, in accordance with an embodiment.

The example shown and described in FIG. 4 is provided for purposes of illustrating an example of one type of communication supported by a microservices environment; in accordance with other embodiments and examples, other types of communication can be supported.

As illustrated in FIG. 4, in accordance with an embodiment, a remote procedure call framework enables definition of a service and methods that can be called remotely. A server or service can handle calls from a client, via a local object (stub) at the client that enables a client application to directly call a method on a server application as if it were a local object. The server/service implements methods to handle client calls, including decoding incoming requests, executing service methods, and encoding service responses. The local object (stub) implements the same methods as the service, wrapping the parameters for the call in an appropriate protocol buffer message type, which is then provided as requests to the server.

In accordance with an embodiment, a microservices library enables access by client applications to communicate with microservices or interact with cloud, database, or other systems or services, for purposes of accessing data, processing transactions, or performing other operations associated with those systems or services.

### Reactive Environments

In a traditional message-driven environment, a producer sends messages to a consumer as they become available; however if the consumer is not able to process the messages in real time then the received messages are stored in a buffer, which can lead to performance issues.

In accordance with an embodiment, a microservices environment can provide a reactive environment, for example a reactive engine or reactive messaging API, for use with activities such as transaction processing, asynchronous messaging channels, or reactive streams.

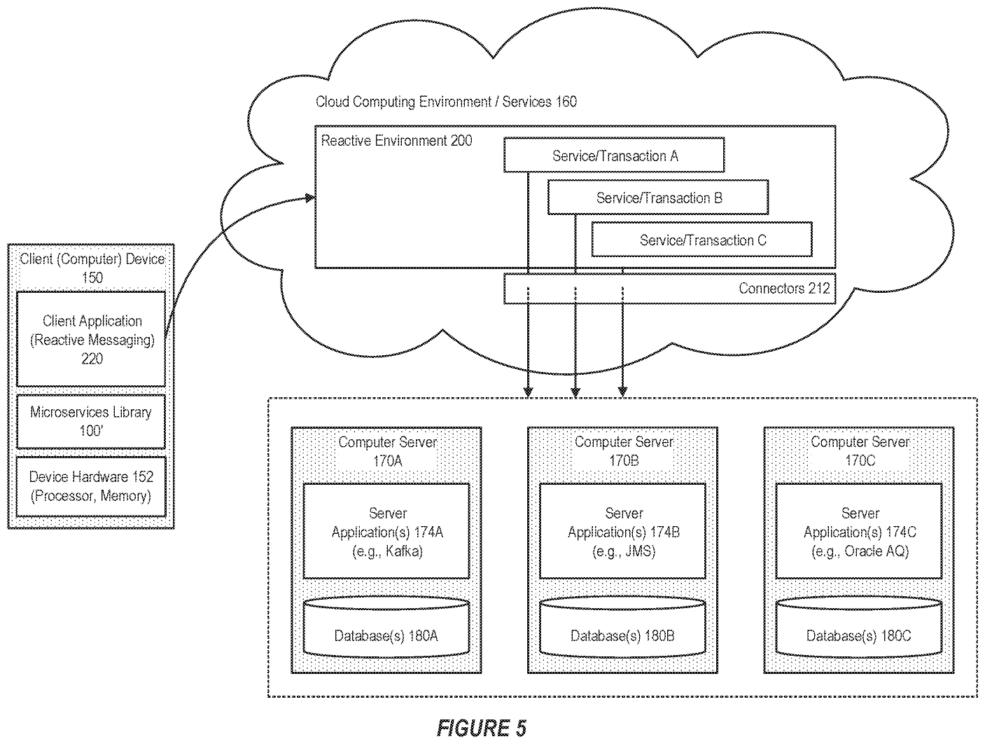

FIG. 5 illustrates the use of a reactive environment in a microservices environment, in accordance with an embodiment.

The example shown and described in FIG. 5 is provided for purposes of illustrating an example of one type or usage of a reactive environment as supported by a microservices environment; in accordance with other embodiments and examples, other types and usages of reactive environments can be provided.

As illustrated in FIG. 5, in accordance with an embodiment, the reactive environment 200 enables a client application 220 to communicate reactively with services, as publishers and subscribers, within the microservices environment. Connectors 212 can be used to provide publishers and subscribers with access to reactive messaging channels, or to provide support for the use of reactive messaging with Kafka, JMS, or other type of messaging, message queueing, or stream processing environments.

In accordance with an embodiment, the reactive environment enables asynchronous stream processing with non-blocking back pressure—a subscriber informs a publisher as to how much data it can process, and the publisher sends an appropriate amount of data as requested by the subscriber.

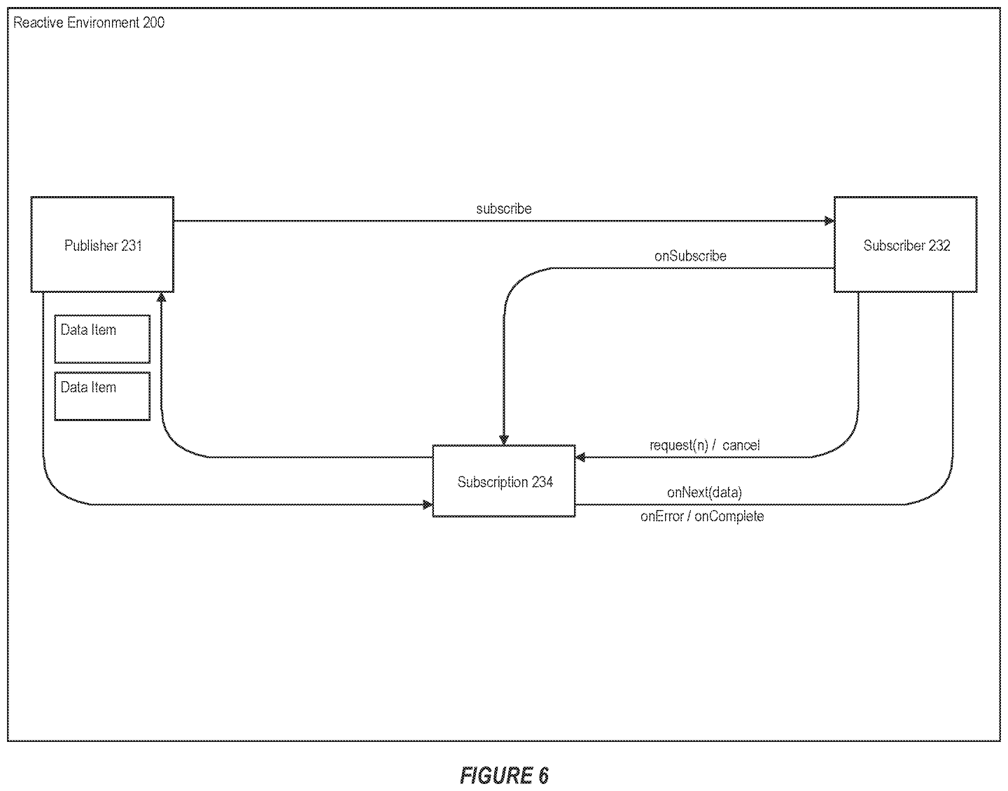

FIG. 6 further illustrates the use of a reactive environment, in accordance with an embodiment.

As illustrated in FIG. 6, in accordance with an embodiment, a publisher 231 (referred to herein in some examples as a Publisher) operates as a producer of data, according to the demand requested by its subscribers. A subscriber 232 (referred to herein in some examples as a Subscriber) operates as a consumer of the data produced by a publisher. A subscription (referred to herein in some examples as a Subscription) 234 defines the relationship between a subscriber subscribing to a publisher, and provides a mechanism by which the subscriber can request more data (from the publisher).

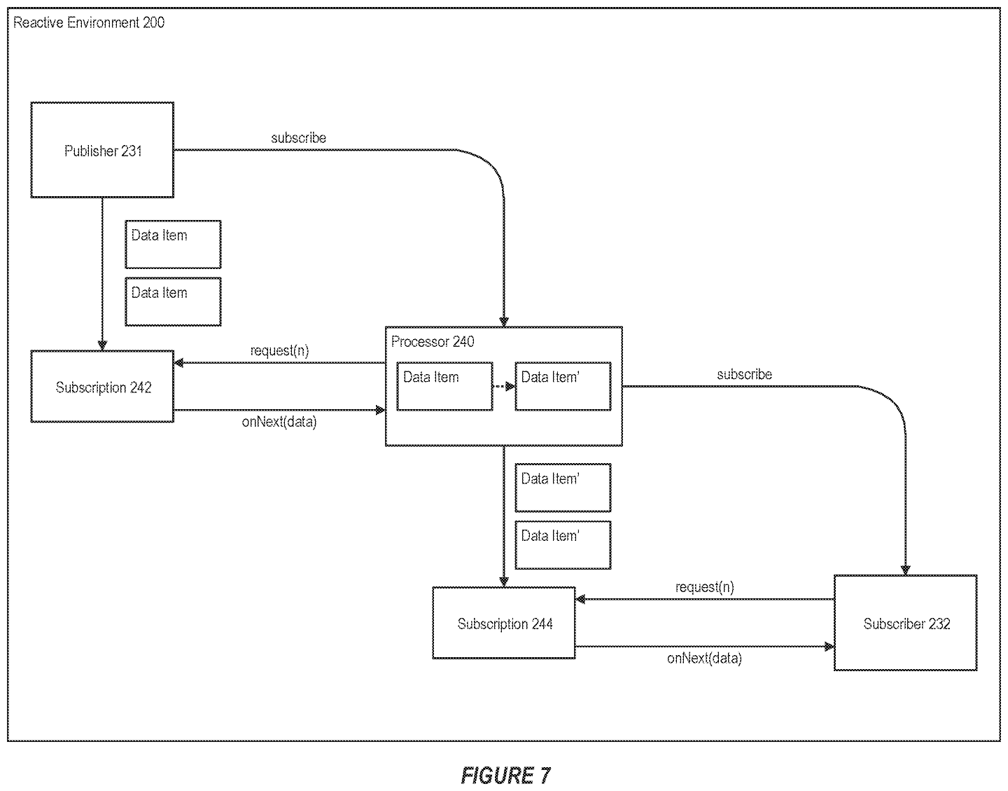

FIG. 7 further illustrates the use of a reactive environment, in accordance with an embodiment.

As illustrated in FIG. 7, in accordance with an embodiment, a processor 240 (referred to herein in some examples as a Processor) operates as a message/data processing stage, and (via subscriptions 242, 244) both as a subscriber and a publisher.

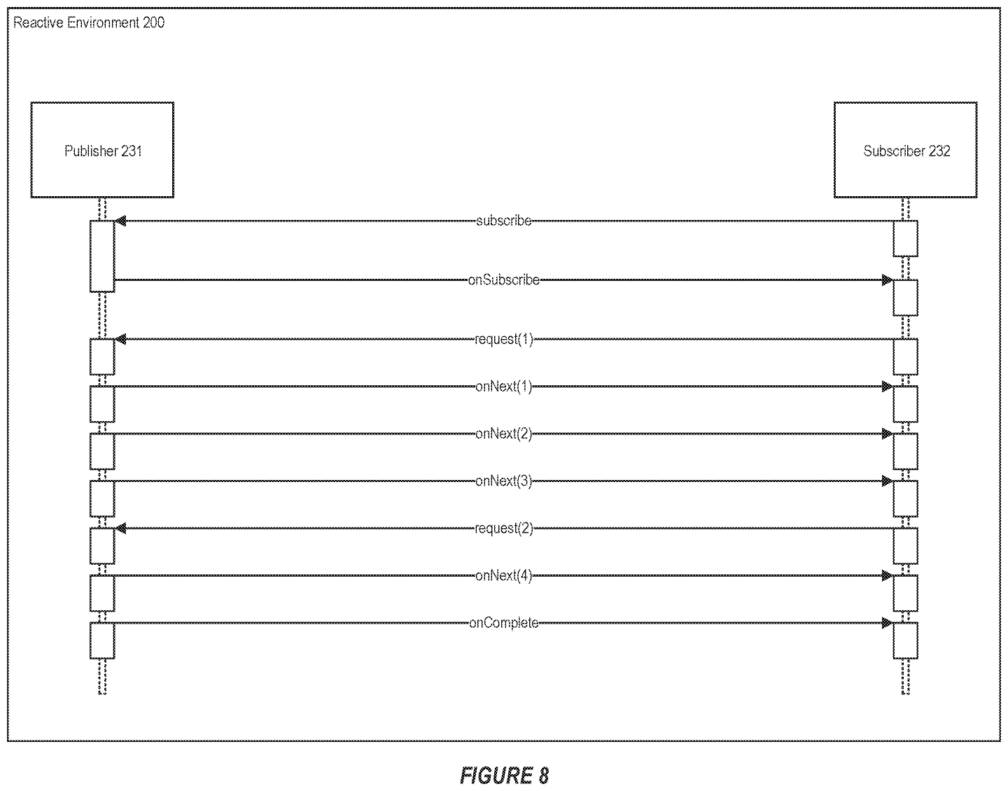

FIG. 8 further illustrates the use of a reactive environment, in accordance with an embodiment.

As illustrated in FIG. 8, in accordance with an embodiment, when a subscriber is passed to a publisher, the subscriber receives a call on method onSubscribe (Subscription), but will not immediately begin to receive data items or other events. Data items are only received by the subscriber when it calls method request (long) within its subscription, which signals to the publisher a demand for more data.

In accordance with an embodiment, a subscriber can receive data through invocation of a method Subscriber.onNext, which is invoked with the next item, and can be called a number (n) times as determined by a long value passed on the method request (long) of its subscription. A method Subscriber.onError ( ) can be invoked when an error occurs while processing the stream. A method Subscriber.onComplete ( ) can be invoked when there is no further data to be processed. In the case of both an onError ( ) and onComplete ( ) event being invoked, then no new data will be emitted by the publisher, even if the method request (long) is called again.

### Reactive Multi-Part MIME Parsing

In accordance with an embodiment, a microservices or other computing environment can include the use of reactive multi-part parsing. In a cloud computing environment, reactive programming can be used with publishers and subscribers, to abstract execution away from the thread of execution while providing rigorous coordination of various state transitions. The described approach provides support for parsing multi-part Multipurpose Internet Mail Extensions (MIME) or other data content, for example to provide a multi-part decoder (referred to herein in some examples as MultiPartDecoder), or as may be used with a web or other server.

In accordance with an embodiment, technical advantages of the described approach include, for example, coordination of: the requirements imposed by the total order of events issued by upstream publisher; the total order of events issued to downstream subscribers; the total order of events emitted by a MIME parser; management of resource ownership; and respect for backpressure throughout in the presence of concurrent errors and cancellations.

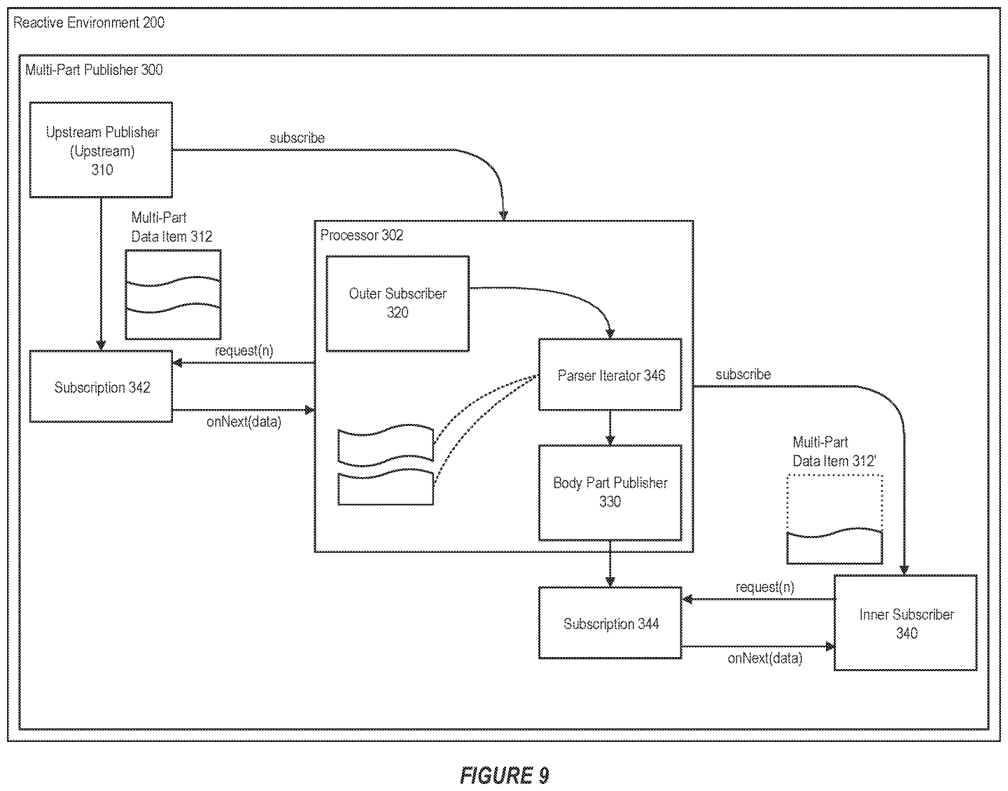

FIGS. 9-16 illustrate a multi-part publisher 300 for use with a microservices or other computing environment, in accordance with an embodiment.

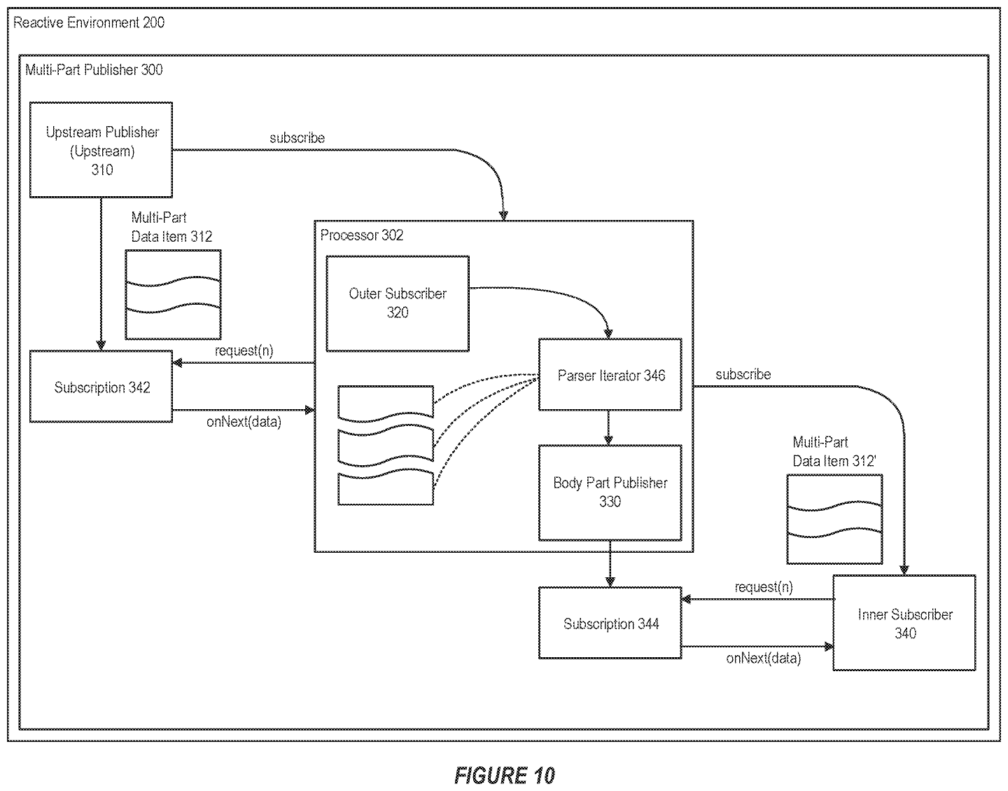

As illustrated in FIGS. 9-10, in accordance with an embodiment, the multi-part publisher operates as a reactive processor 302 (referred to herein in some examples as a Processor) that provides parsing of multi-part MIME or other data content 312 provided by an upstream publisher (Publisher) 310, via operation of an outer subscriber (Subscriber) 320, body part publisher (referred to herein in some examples as a bodyPartPublisher) 330, and inner subscriber 340, according to subscriptions 342, 344, and a parser iterator 346, as illustrated and described below.

Generally described, the upstream component operates as a source to provide new data chunks, for example as provided by a socket reader; while the outer subscriber operates to control a flow of data chunks; the body part publisher operates as an instance that sends data chunks that belong, for example, to a MIME data; and the inner subscriber operates as an entity attached to the body part publisher, so that it can operate, for example in the manner of a nested list, on a stream of streams of data chunks.

In accordance with an embodiment, the outer subscriber can initially request one (or more), e.g. MIME, data body parts from the upstream component. Since a data chunk may contain a number of data body parts, the system can request one data body part at a time, to reduce backpressure. Following an upstream request, the upstream component, e.g., socket reader, can eventually invoke onNext, which results in parsing events being exposed as an iterator. Eventually, the system will observe that the iterator has produced an END_HEADERS event. When this happens, the process will create a body part publisher instance.

In accordance with an embodiment, the system or process will then tell the outer subscriber that a new data body part is available; and the outer subscriber can attach an inner subscriber to the body part publisher instance, by invoking subscribe on the body part publisher instance.

In accordance with an embodiment, to reduce backpressure, until the inner subscriber invokes or requests a new data body part, the parser is not required to produce new events from upstream, and is effectively suspended. Subsequently, the iterator will observe data body parts and attempt to invoke drain on inner subscriber. the body part publisher will wait for a request from inner subscriber to request more data chunks.

In accordance with an embodiment, when the body part publisher is drained; then the body part publisher can receive a next chunk of data. If the parser iterator says there are no more events, then it can request further chunks from upstream. Once the parser produces an END_PART event, then the body part publisher can notify the inner subscriber that the processing has completed. Subsequently, the outer subscriber can wait for more data body parts; and data can again be received from upstream; until receipt of an onComplete event.

In accordance with an embodiment, the described approach addresses various requirements of a reactive environment, for example:

In accordance with an embodiment, a reactive Processor should assume it is used concurrently, and yet deliver signals to downstream in a total order. When an error occurs, it must be routed downstream, since the Processor may have more than one downstream over time, and a given error may be signaled to many Subscribers if needed. Resources pinned by the Processor should be released as soon as they are no longer needed and it is practical to do so: subsequent requests or cancellations may occur at some arbitrary time in the future. Similarly, whenever the Processor is known to have entered a terminal state (via a cancellation or bad request), it must release any resources.

In accordance with an embodiment, a Subscriber may cancel their subscription; which should translate into a cancellation of an upstream subscription at the appropriate time: an inner Subscriber should allow the outer Subscriber to make progress; and outer Subscribers should not cancel an upstream subscription while the inner Subscriber may need to interact with the upstream to make progress.

In accordance with an embodiment, a Subscriber may issue bad requests; which should translate into a cancellation of an upstream subscription at the appropriate time: an inner Subscriber should allow the outer Subscriber to make progress; and an outer Subscriber should not generate errors that can be seen by the inner Subscriber.

In accordance with an embodiment, the described approach uses a DataChunk, and as such needs to keep track of which entity owns the DataChunk and has responsibility to release it, which is important, for example, for cases when DataChunk is backed by Netty buffers.

In accordance with an embodiment, all interactions with upstream, parser, or any of the Subscriber can be performed in drainBoth ( ), which is guaranteed to be executed single-threadedly, with appropriate memory fences between any two invocations of drainBoth ( ). This allows much of the state to be implemented as non-thread-safe data structures. The operation of the Processor can be understood by observing the drainBoth ( ) method alone. The remaining approach then provides a way to cause drainBoth ( ) to make further state transitions.

In accordance with an embodiment, the state is described by: error, for errors that need to be signalled to both inner and outer Subscriber (produced by the parser or upstream); cancelled, for cancellations signalled by outer Subscriber parser: a helper object to capture parser state across multiple DataChunk; iterator, a parser iterator that holds ParserEvents and is used to transition parser state; partsRequested, for outer Subscriber to indicate demand for MIME parts; and demand for DataChunks by inner Subscriber (exposed by DataChunkPublisher through an API).

In accordance with an embodiment, whenever any of these change, the function drain ( ) is called to enter drainBoth ( ) or demand to re-do it again, if a thread already inside drainBoth ( ) is detected. Additionally, care is taken when dealing with: upstream: to interact with upstream; downstream: outer Subscriber; bodyPartPublisher: a special Publisher that interacts with inner Subscriber.

In accordance with an embodiment, at a high level, drainBoth ( ) operates like a flat map of a stream of DataChunk into a stream of ParserEvents: [DataChunk]→[[ParserEvent]]→[ParserEvent], which then is fanned out into a stream of streams of DataChunk: [ParserEvent]→[ReadableBodyPart], which is in essence [ParserEvent]→[[DataChunk]].

In accordance with an embodiment, DataChunk are requested from upstream one at a time. Using this approach, the system does not retain too many DataChunk, and flattening [[ParserEvent]] is trivial. This is ensured by inner and outer Subscriber detecting when the demand changes from zero. Additionally, the demand of the outer Subscriber can become zero only after the next part is completed; this means that the demand of the outer Subscriber is in essence unable to issue upstream request until after the inner Subscriber is completed.

In accordance with an embodiment, DataChunk are not requested, nor are any errors signalled, while the parser iterator is able to produce more ParserEvents. All onError events are totally ordered after all possible onNext that can be emitted without requesting more DataChunk from upstream.

In accordance with an embodiment, the parser iterator does not produce more events, unless there is evidence of demand from inner or outer Subscriber. Outer Subscriber demand is ignored while there is a bodyPartPublisher responsible for handing the demand of an inner Subscriber. Cancellation or error state of inner Subscriber appears to drainBoth ( ) as a demand for infinite number of DataChunk. This way the system can make progress to the end of the MIME part, and serve the demand of the outer Subscriber if any. Inner Subscriber demand is determined by inner Subscriber calling drain ( ), and observing that bodyPartPublisher is unable to satisfy the demand.

In accordance with an embodiment, the parser iterator is not asked for more events, while there is a bodyPartPublisher, and it satisfies the demand for DataChunk by inner Subscriber by the DataChunk already given to it.

### Data Chunk Publisher

In accordance with an embodiment, an inner Subscriber can be handled using a data chunk publisher (referred to herein in some examples as a DataChunkPublisher); in essence as a flat map [[DataChunk]]→[DataChunk] (given iterators of BufferEntry, one at a time, emits DataChunk one at a time). The design operates to:

Keep track of change of demand and cancellations of inner Subscriber.

Expose methods to allow total order of signals emitted by drainBoth ( ).

When cancelled, or a bad request is received, appear as unlimited unsatisfied demand, and merely discard all DataChunk that are received.

Relies on drainBoth ( ) not attempting to deliver onError before the previous iterator of BufferEntry is emptied; this simplifies resource management.

### Initialization

In accordance with an embodiment, both MultiPartDecoder and DataChunkPublisher share a similar approach, in that they have an atomic counter that: is initialized to a value indicating the uninitialized state that can never occur naturally throughout the Publisher lifetime; can be transitioned into “subscribed” state once and only once in its lifetime; and is finally transitioned into initialized state only after onSubscribe has returned.

This ensures that no more than one Subscriber is associated with the Publisher and enforces the rule that all on* signals get delivered only after onSubscribe and none during onSubscribe.

The MultiPartDecoder has two ends that need initializing: upstream signalling onSubscribe, potentially immediately followed by onError or onComplete for empty upstream; downstream outer Subscriber being attached by subscribe ( ). The use of a contenders atomic counter allows the system to synchronize all these.

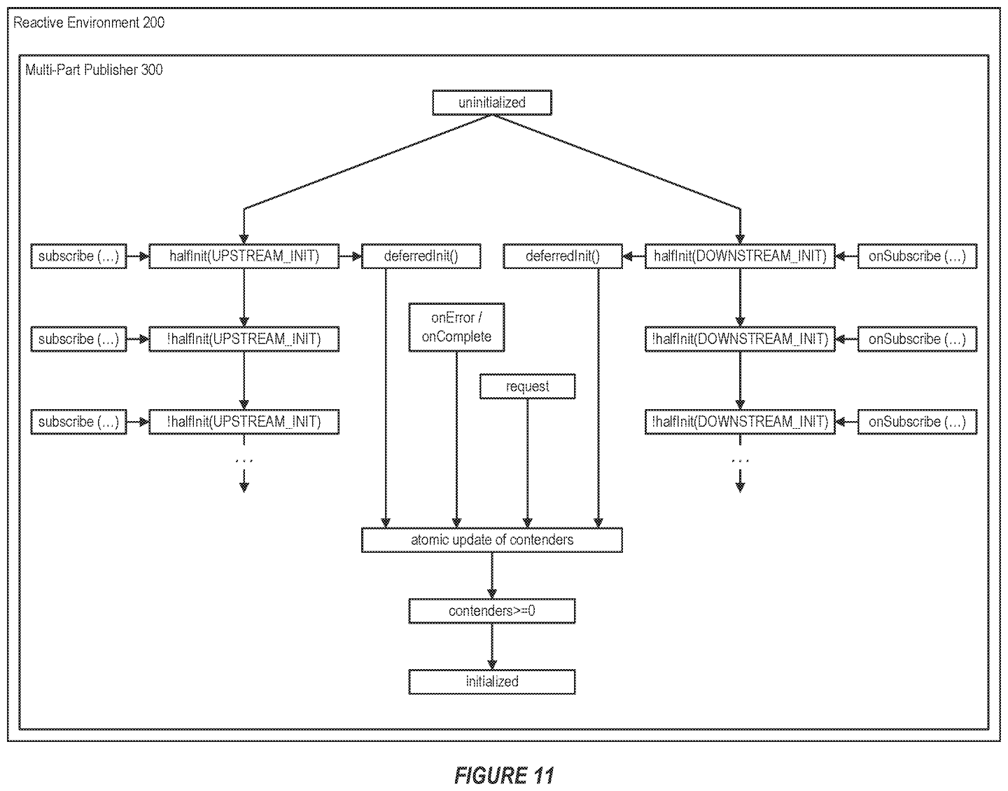

As illustrated in FIG. 11, in accordance with an embodiment, a partial order of possible events includes: halfInit ( ) which ensures that one and only one of UPSTREAM_INIT/DOWNSTREAM_INIT returns true, and any subsequent future invocations with the same argument get false. Of all atomic updates of contenders counter only the updates by deferredInit ( ) are able to turn the value into a non-negative. All other updates observe they are “locked out” from entering drainBoth ( ).

In accordance with an embodiment, a second deferredInit ( ) can witness if any of onError/oncomplete/request happened, and enter drainBoth ( ) on their behalf. Uninitialized state is represented by Integer.MIN_VALUE (0b1000). Each end attempts to transition to half-initialized for their end, unless it is already initialized. It is safe to enter drainBoth ( ) only after both ends have initialized, so the number of ends that have been initialized is tracked as the fourth bit: each end tries to add SUBSCRIPTION_LOCK (0b0001). Before the second of them, the counter necessarily appears as 0b1111, and adding SUBSCRIPTION_LOCK clears all the high bits, leaving only zero, unless there were already attempts to enter drainBoth ( ) by outer Subscriber requesting parts as part of onSubscribe, or by upstream delivering onError or onComplete, which are allowed to occur without requests from downstream.

### Normal Process Flow

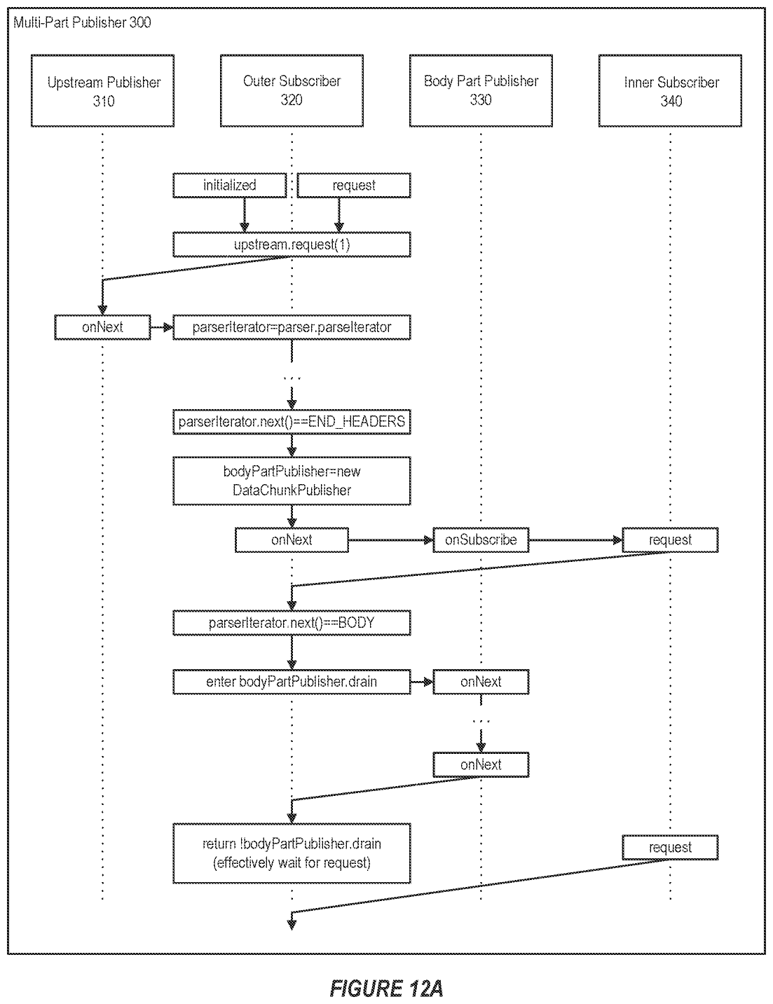

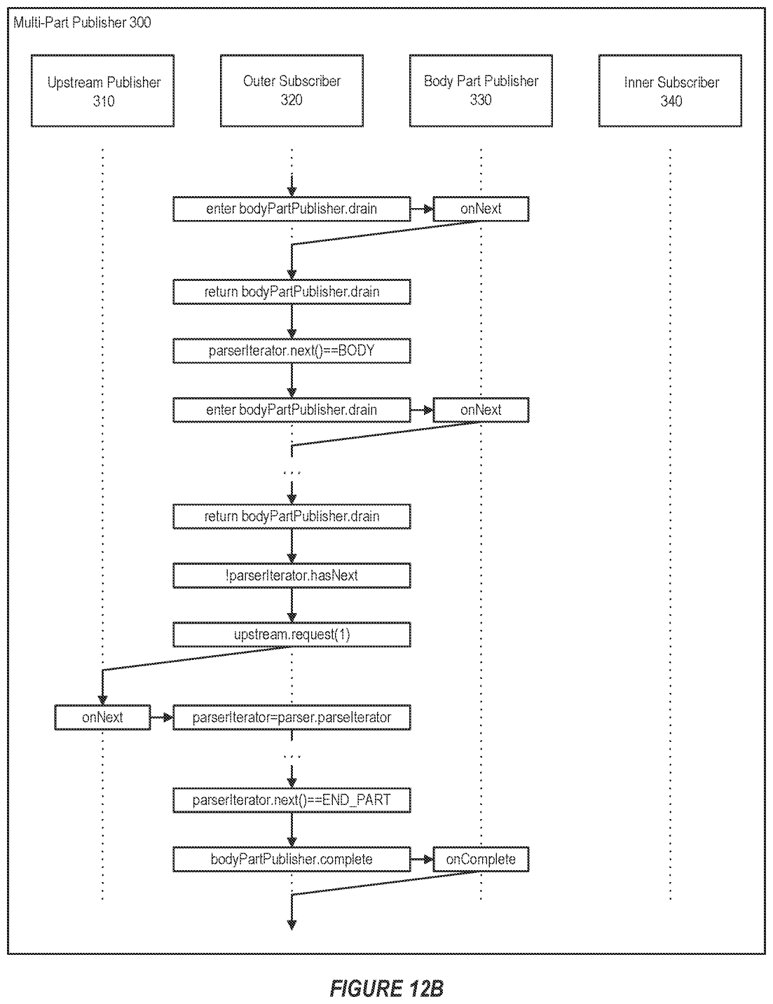

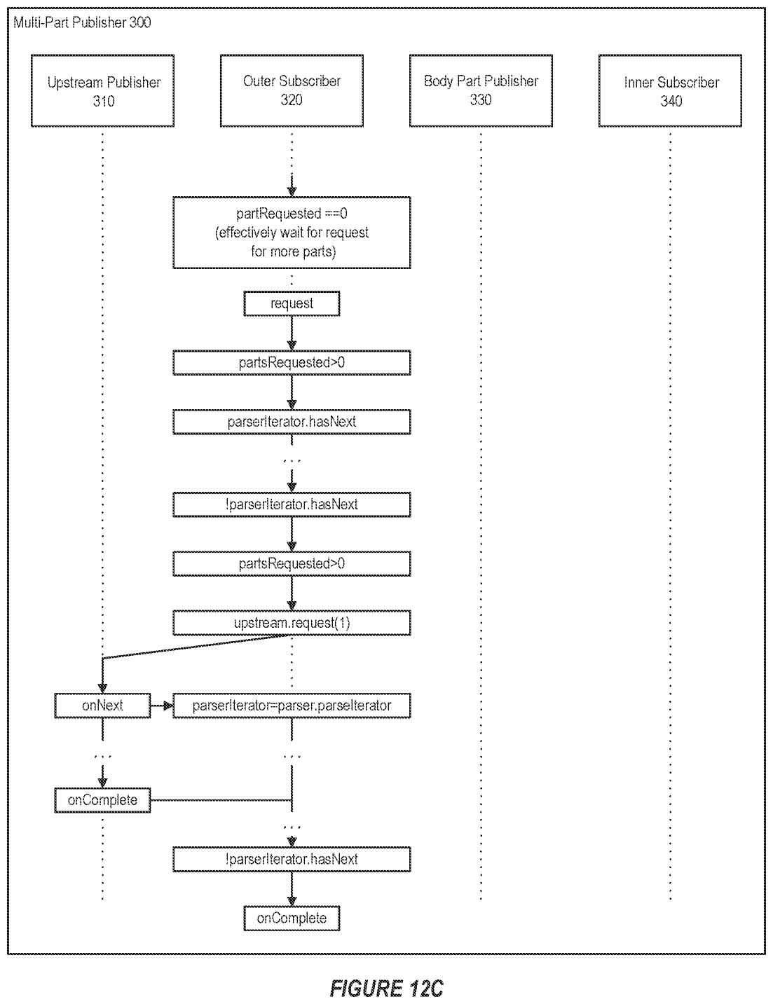

As illustrated in FIGS. 12A-12C, in accordance with an embodiment, a normal flow of events may involve various components or entities, including for example, an upstream; an outer Subscriber; a bodyPartPublisher; and an inner Subscriber.

As described above, the upstream component generally operates as a source to provide new data chunks, for example as provided by a socket reader; the outer Subscriber entity generally operates to control the flow of data chunks; the bodyPartPublisher generally operates as an instance that sends data chunks that belong, for example, to a MIME data; and the inner Subscriber generally operates as an entity attached to the bodyPartPublisher, so that it can operate, for example in the manner of a nested list, on a stream of streams of data chunks.

In accordance with an embodiment, the outer Subscriber can initially request one (or more), e.g. MIME, data body parts from the upstream component. Since a data chunk may contain a number of data body parts, the system can request one data body part at a time, to reduce backpressure. Following an upstream request, the upstream component, e.g., socket reader, can eventually invoke onNext, which results in parsing events being exposed as an iterator. Eventually, the system will observe that the iterator has produced an END_HEADERS event. When this happens, the process will create a bodyPartPublisher instance.

In accordance with an embodiment, the system or process will then tell the outer Subscriber that a new data body part is available; and the outer Subscriber can attach an inner Subscriber to the bodyPartPublisher instance, by invoking subscribe on the bodyPartPublisher instance.

In accordance with an embodiment, to reduce backpressure, until the inner Subscriber invokes or requests a new data body part, the parser is not required to produce new events from upstream, and is effectively suspended. Subsequently, the iterator will observe data body parts and attempt to invoke drain on inner Subscriber. The bodyPartPublisher will wait for a request from inner Subscriber to request more data chunks.

In accordance with an embodiment, when bodyPartPublisher is drained; then the bodyPartPublisher can receive a next chunk of data. If the parser iterator says there are no more events, then it can request further chunks from upstream. Once the parser produces an END_PART event, then bodyPartPublisher can notify the inner Subscriber that the processing has completed. Subsequently, outer Subscriber can wait for more data body parts; and data can again be received from upstream; until receipt of an onComplete event.

Processes Associated with Errors and Cancellations

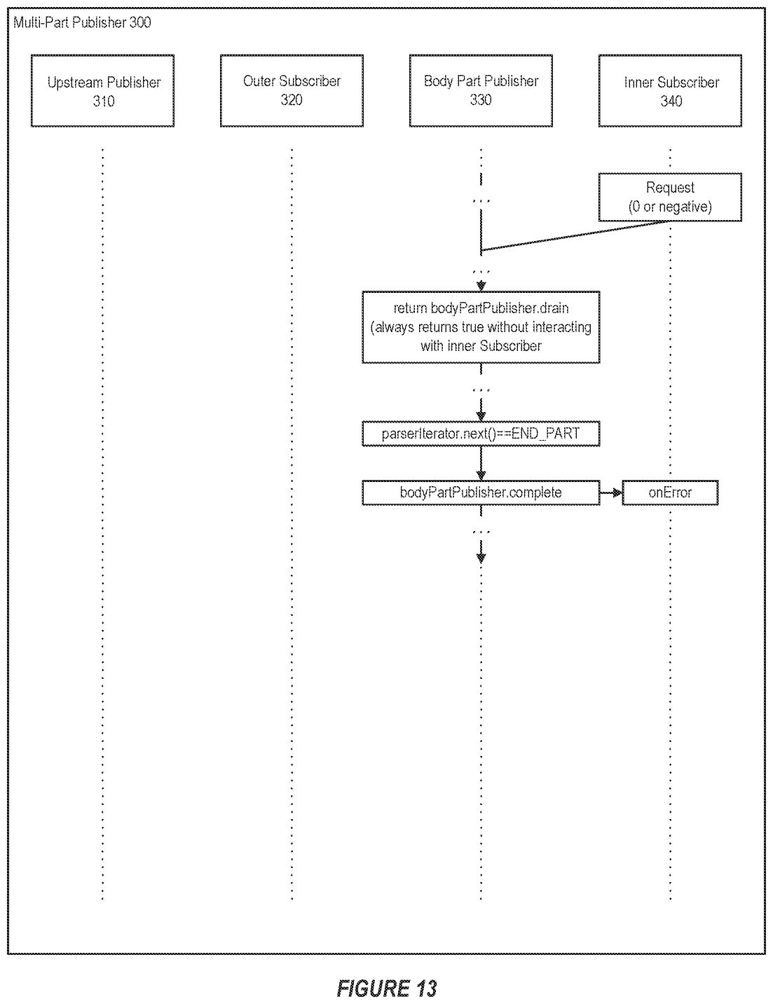

FIGS. 13-18 illustrates various examples of processes associated with errors and cancellations, in accordance with an embodiment, wherein:

FIG. 13 illustrates an example flow of events when inner Subscriber makes a bad request: this state is not visible to anyone but bodyPartPublisher—the inner subscription appears as the one with the forever unsatisfied demand;

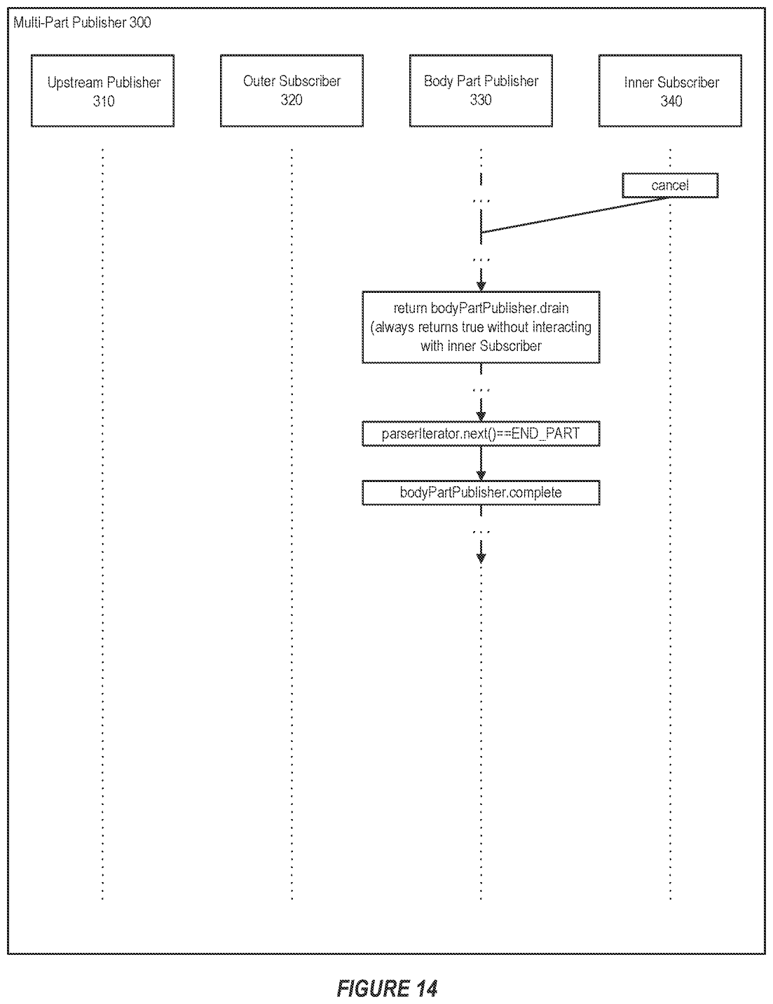

FIG. 14 illustrates an example flow of events when inner Subscriber cancels: this state is not visible to anyone but bodyPartPublisher—the inner subscription appears as the one with the forever unsatisfied demand;

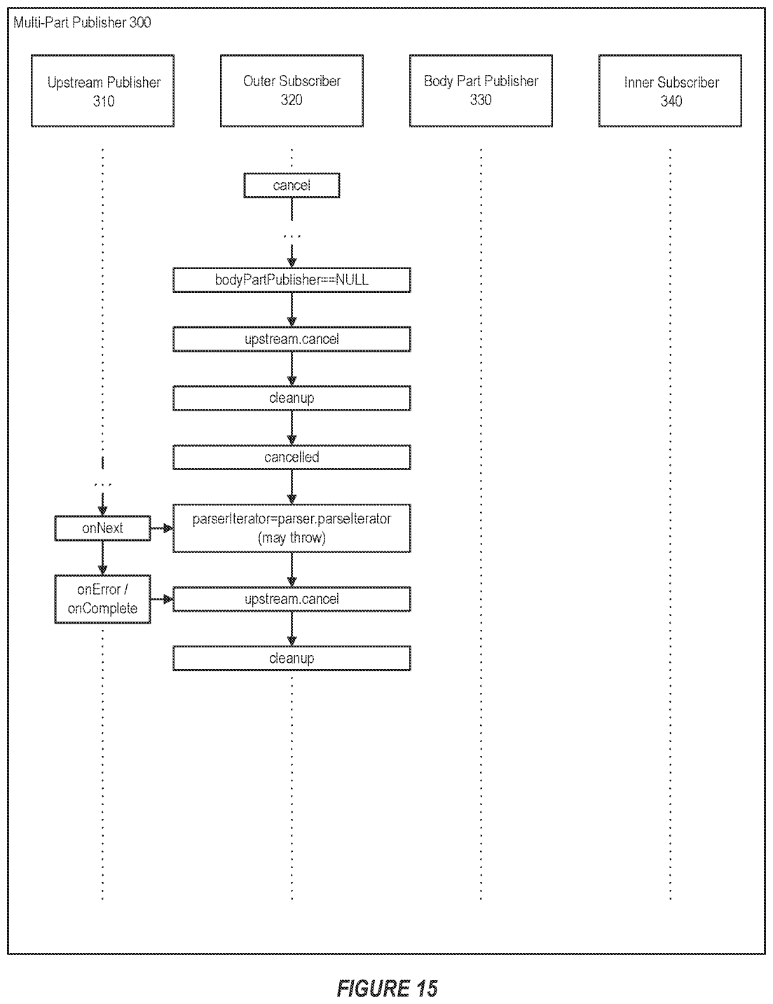

FIG. 15 illustrates an example flow of events when outer Subscriber cancels: it is difficult to depict the absence of events signalled to downstream exactly;

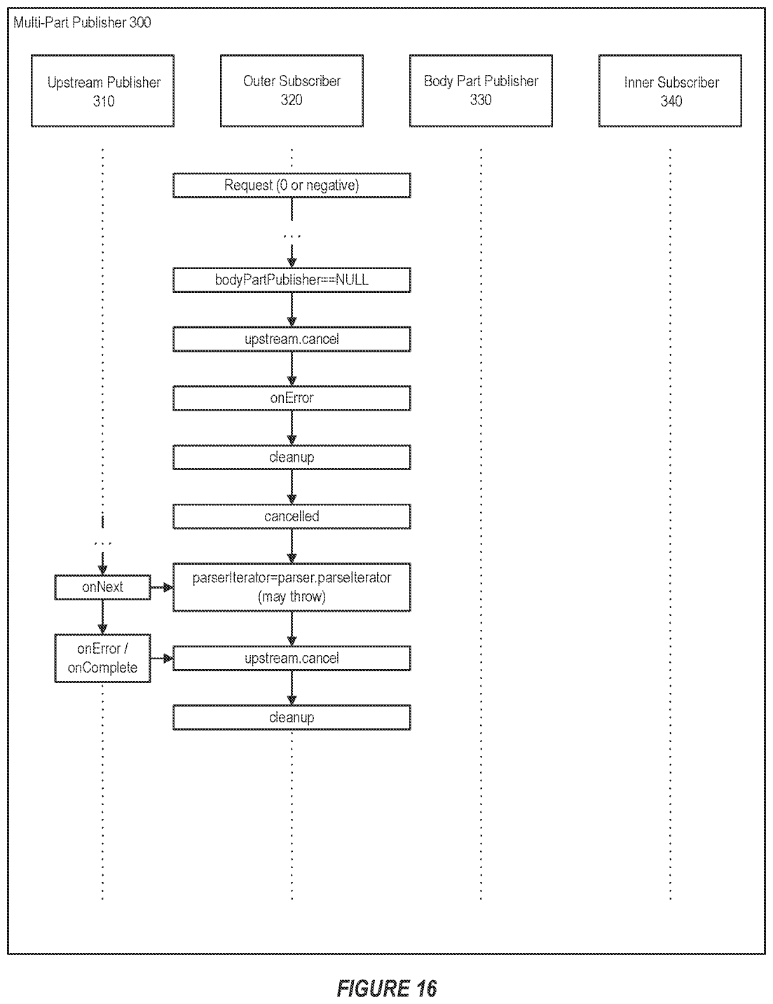

FIG. 16 illustrates an example flow of events when outer Subscriber makes a bad request: as soon as the current part is done, report onError, and appear to upstream as a cancelled subscription after that;

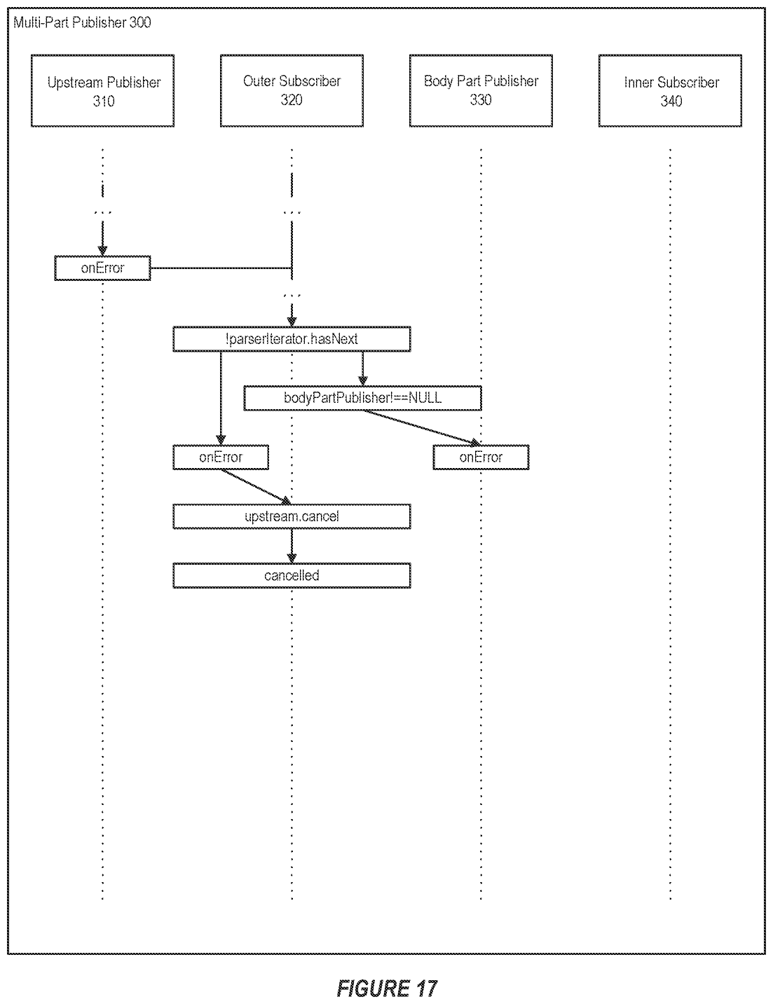

FIG. 17 illustrates an example flow of events when upstream reports onError; and

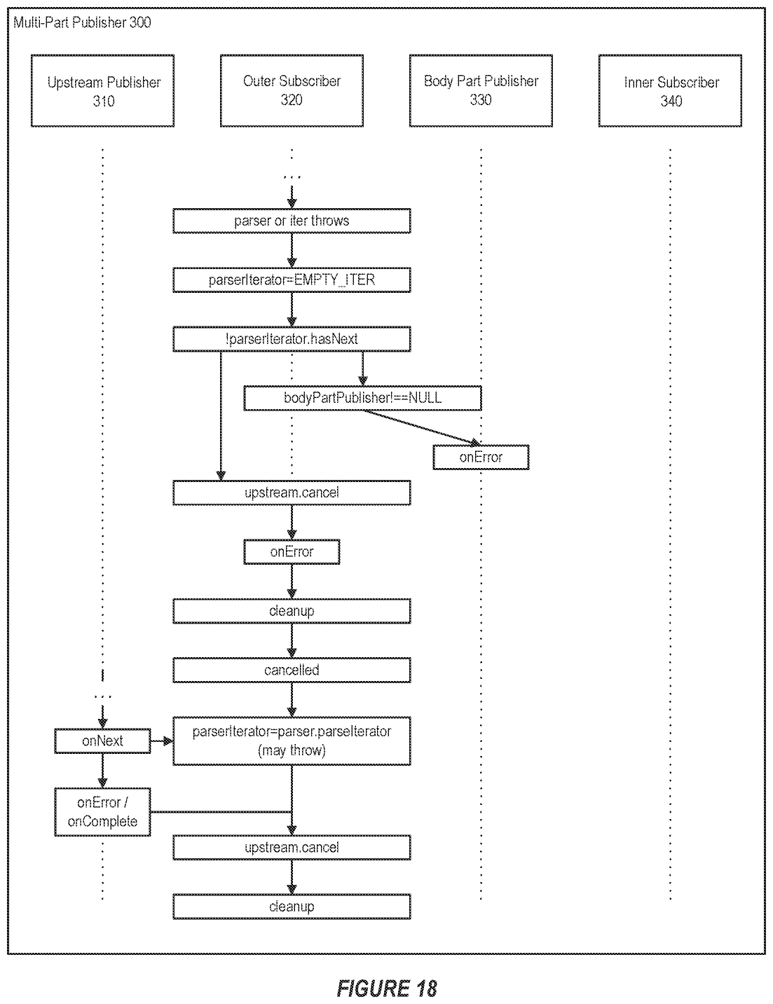

FIG. 18 illustrates an example flow of events when Parser throws: as soon as the next parser event is requested; Report to inner and outer Subscriber, appear to upstream as a cancelled subscription.

In accordance with various embodiments, the teachings herein may be conveniently implemented using one or more conventional general purpose or specialized computer, computing device, machine, or microprocessor, including one or more processors, memory and/or computer readable storage media programmed according to the teachings of the present disclosure. Appropriate software coding can readily be prepared by skilled programmers based on the teachings of the present disclosure, as will be apparent to those skilled in the software art.

In some embodiments, the teachings herein can include a computer program product which is a non-transitory computer readable storage medium (media) having instructions stored thereon/in which can be used to program a computer to perform any of the processes of the present teachings. Examples of such storage mediums can include, but are not limited to, hard disk drives, hard disks, hard drives, fixed disks, or other electromechanical data storage devices, floppy disks, optical discs, DVD, CD-ROMs, microdrive, and magneto-optical disks, ROMs, RAMs, EPROMs, EEPROMs, DRAMs, VRAMs, flash memory devices, magnetic or optical cards, nanosystems, or other types of storage media or devices suitable for non-transitory storage of instructions and/or data.

The foregoing description has been provided for the purposes of illustration and description. It is not intended to be exhaustive or to limit the scope of protection to the precise forms disclosed. Many modifications and variations will be apparent to the practitioner skilled in the art.

For example, although various embodiments of the systems and methods described herein illustrate usage in a Helidon microservices environment, various embodiments can be used with other types of microservice environments or other computing environments.

The embodiments were chosen and described in order to best explain the principles of the present teachings and their practical application, thereby enabling others skilled in the art to understand the various embodiments and with various modifications that are suited to the particular use contemplated. It is intended that the scope be defined by the following claims and their equivalents.

What is claimed is:

1. A system for parsing multi-part data content, for use with a microservices or other computing environment, comprising:
a computer including one or more processors, that provides access to a microservices or other computing environment, for use with software applications;
wherein the system supports processing of streams involving one or more publishers and subscribers, wherein a publisher publishes a stream of data, and a subscriber consumes the data; and
a multi-part decoder component that provides support for parsing data content.

2. The system of claim 1, wherein the data content is Multipurpose Internet Mail Extensions (MIME) or other data content.

3. The system of claim 1, wherein a body part publisher operates as an instance that sends data chunks.

4. The system of claim 1, wherein:
an outer subscriber operates to control a flow of data chunks;
a body part publisher operates as an instance that sends data chunks; and
an inner subscriber operates as an entity attached to the body part publisher, so that it can operate on a stream of streams of data chunks.

5. The system of claim 1, wherein an upstream component operates as a source to provide new data chunks;
while an outer subscriber operates to control a flow of data chunks;
a body part publisher operates as an instance that sends data chunks; and
an inner subscriber operates as an entity attached to the body part publisher, so that it can operate on a stream of streams of data chunks.

6. The system of claim 1, wherein an outer subscriber can initially request one or more data body parts from an upstream component, wherein the system can request one data body part at a time, to reduce backpressure, by the upstream component invoking onNext, which results in parsing events being exposed as an iterator.

7. The system of claim 1, wherein the microservices or other computing environment is provided within a cloud computing environment that provides access to cloud, database, or other systems or services.

8. A method for parsing multi-part data content, for use with a microservices or other computing environment, comprising:
providing, at a computer including one or more processors, a microservices or other computing environment, for use with software applications;
processing streams involving one or more publishers and subscribers, wherein a publisher publishes a stream of data, and a subscriber consumes the data; and
providing a multi-part decoder component that provides support for parsing data content.

9. The method of claim 8, wherein the data content is Multipurpose Internet Mail Extensions (MIME) or other data content.

10. The method of claim 8, wherein a body part publisher operates as an instance that sends data chunks.

11. The method of claim 8, wherein:
an outer subscriber operates to control a flow of data chunks;
a body part publisher operates as an instance that sends data chunks; and
an inner subscriber operates as an entity attached to the body part publisher, so that it can operate on a stream of streams of data chunks.

12. The method of claim 8, wherein an upstream component operates as a source to provide new data chunks;
while an outer subscriber operates to control a flow of data chunks;
a body part publisher operates as an instance that sends data chunks; and
an inner subscriber operates as an entity attached to the body part publisher, so that it can operate on a stream of streams of data chunks.

13. The method of claim 8, wherein an outer subscriber can initially request one or more data body parts from an upstream component, wherein the system can request one data body part at a time, to reduce backpressure, by the upstream component invoking onNext, which results in parsing events being exposed as an iterator.

14. The method of claim 8, wherein the microservices or other computing environment is provided within a cloud computing environment that provides access to cloud, database, or other systems or services.

15. A non-transitory computer readable storage medium, including instructions stored thereon which when read and executed by one or more computers cause the one or more computers to perform the steps comprising:
provide a microservices or other computing environment, for use with software applications;
process streams involving one or more publishers and subscribers, wherein a publisher publishes a stream of data, and a subscriber consumes the data; and
provide a multi-part decoder component that provides support for parsing data content.

16. The non-transitory computer readable storage medium of claim 15, wherein the data content is Multipurpose Internet Mail Extensions (MIME) or other data content.

17. The non-transitory computer readable storage medium of claim 15, wherein a body part publisher operates as an instance that sends data chunks.

18. The non-transitory computer readable storage medium of claim 15, wherein an upstream component operates as a source to provide new data chunks;
while an outer subscriber operates to control a flow of data chunks;
a body part publisher operates as an instance that sends data chunks; and
an inner subscriber operates as an entity attached to the body part publisher, so that it can operate on a stream of streams of data chunks.

19. The non-transitory computer readable storage medium of claim 15, wherein an outer subscriber can initially request one or more data body parts from an upstream component, wherein the system can request one data body part at a time, to reduce backpressure, by the upstream component invoking onNext, which results in parsing events being exposed as an iterator.

20. The non-transitory computer readable storage medium of claim 15, wherein the microservices or other computing environment is provided within a cloud computing environment that provides access to cloud, database, or other systems or services.
